(19) United States
(12) Patent Application Publication
(10) Pub. No.: US 2017/0095065 A1
(43) Pub. Date: Apr. 6, 2017

(54) PROTECTIVE CASE

(71) Applicants: Mark J. Colbert, Las Vegas, NV (US); Penny L. King, Las Vegas, NV (US)

(72) Inventors: Mark J. Colbert, Las Vegas, NV (US); Penny L. King, Las Vegas, NV (US)

(21) Appl. No.: 15/278,999

(22) Filed: Sep. 28, 2016

Related U.S. Application Data
(60) Provisional application No. 62/284,468, filed on Oct. 1, 2015.

(51) Int. Cl. A45F 5/00; B65D 43/22; H04B 1/3888; A45C 13/00; H04M 1/18; B65D 43/16; A45C 11/00

(52) U.S. Cl. CPC A45F 5/00; B65D 43/16; B65D 43/22; A45C 11/00; A45C 13/008; H04M 1/18; H04B 1/3888; A45C 2011/002; A45C 13/002; H04B 2001/3894

(57) ABSTRACT

A protective case protects a communication device and an item, such as credit cards and money. The protective case is fabricated from a material inhibiting moisture, providing buoyancy, and minimizing shock forces. The protective case comprises a first compartment for storage of the communication device and a second compartment for storage of the item. A lid having a seal inhibits passage of moisture in the compartments. A grip portion enhances grip of the protective case. A tethering portion enables tethering of the protective case to a user. A tether locking portion, slides along the tethering portion for length adjustment. An aperture aligns with a socket in the communication device receiving a cable carrying a signal to the communication device. A cap inhibits passage of moisture into the aperture. At least one opening in the protective case enables detachable attachment of the tethering portion and a fastener.

### CROSS-REFERENCE TO RELATED APPLICATIONS

The present Utility patent application claims priority benefit of the [U.S. provisional application for patent Ser. No. 62/284,468 filed on 1 Oct. 2015 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a protective case. More particularly, certain embodiments of the invention relates to a protective case that is configured to receive and at least partially protect a communication device and at least one item in separate compartments through the use of a material that inhibits moisture, provides buoyancy, and minimizes shock forces; further including a grip portion that enhances grip of the protective case; and further including a tethering portion that is length adjustable for adjustable attachment of the protective case to a user; and further including an aperture for receiving a cable that carries a signal to the communication device in the protective case, and a cap for inhibiting passage of moisture into the aperture; and further including at least one opening in the protective case for enabling detachable attachment of the tethering portion and a fastener.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that phone cases are designed to attach to, support, or otherwise hold a mobile phone.

Generally, phone cases are popular accessories for protecting phones, particularly smart phones having large display screens and electrical components contained therein. The phone cases often cover a substantial portion of the smart phone, leaving the display and sockets open for operation thereof.

It is known that as the use of smart phones continues to increase, the need for a protective case to surround and protect the expensive device as it is carried and used throughout the day during a variety of user activities has increased. Often, users carry the smart phone in a bag, backpack, purse, or pocket.

Typically, water sport activities involve immersion in water while performing physical activity. The smart phone and other items may be necessary to keep at hand while performing the water activities. Often, water, dirt, and dust can cause all kinds of performance malfunctions for a smart phone.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a top angle perspective view of an exemplary protective case, in accordance with an embodiment of the present invention;

FIG. 2 illustrates a close-up view of an exemplary lid in a closed position and an open position showing an exemplary first compartment and an exemplary second compartment, in accordance with an embodiment of the present invention;

FIG. 3 illustrates a close up view of a first compartment receiving a communication device and a second compartment receiving at least one item, in accordance with an embodiment of the present invention;

FIG. 4 illustrates a bottom perspective view of an exemplary aperture for receiving a cable, and at least one opening for detachably attaching the protective case with a fastening mechanism, in accordance with an embodiment of the present invention;

FIGS. 5A and 5B illustrate front perspective views of an exemplary tethering portion, where FIG. 5A illustrates a tether locking portion distally positioned from the neck end, and FIG. 5B illustrates the protective case connected to the tethering portion, with the protective case hanging loosely around the neck, in accordance with an embodiment of the present invention; and

FIGS. 6A and 6B illustrate front perspective views of an exemplary tethering portion, where FIG. 6A illustrates a tether locking portion proximally positioned near the neck end, and FIG. 6B illustrates the protective case connected to the tethering portion, with the protective case hanging tightly around the neck, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rocklatex Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

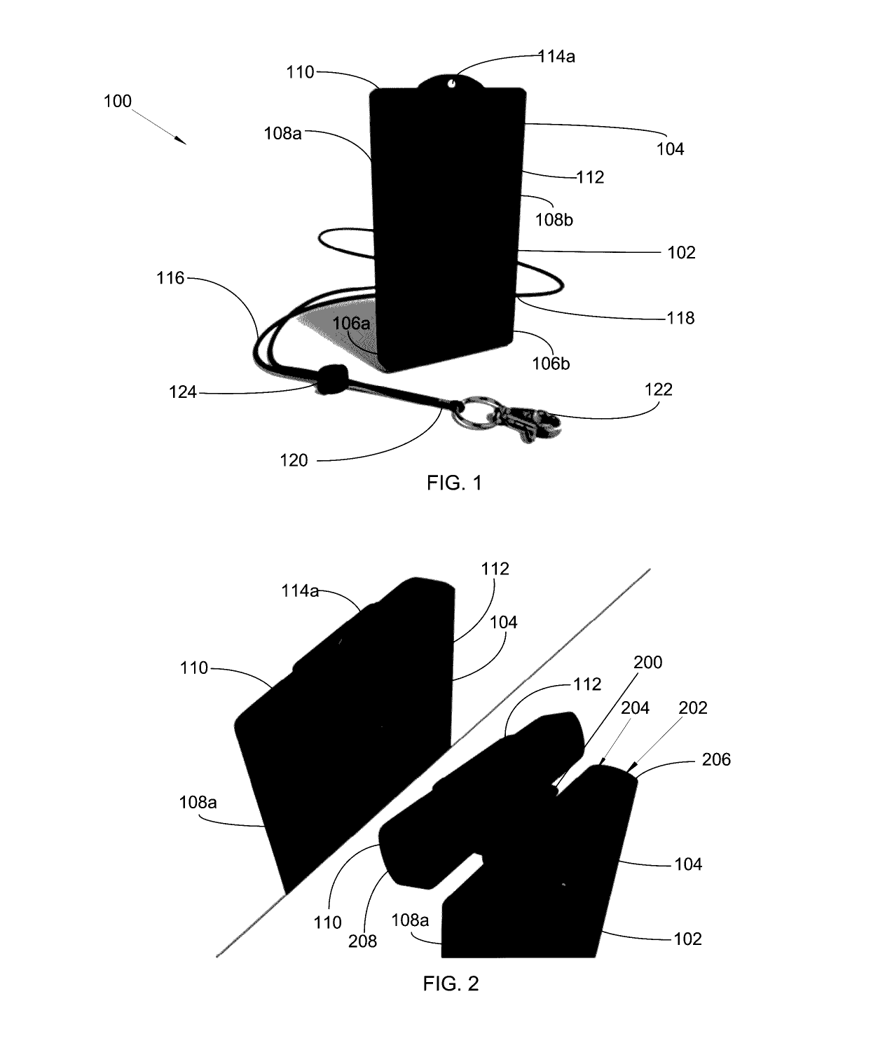

There are various types of smart phone cases that may be provided by preferred embodiments of the present invention. FIG. 1 illustrates a perspective view of an exemplary protective case 100 for protectively containing, accessing, and enabling facilitated operation of a communication device and at least one item. In one aspect, the protective case is configured to receive and at least partially protect a communication device and at least one item in separate compartments. The protective case is fabricated from a material that inhibits moisture, provides buoyancy, and minimizes shock forces. In this manner, the communication device and item are thoroughly protected. This protection against moisture, especially, enables unfettered participation in water related activities while maintaining the communication device within reach. Further, because the protective case has a length adjustable tethering mechanism, unfortunate events such as theft or accidental dropping of the communication device may be inhibited.

Those skilled in the art will recognize that the protective case is effective for providing protection to smartphones in areas with or near water, such as beaches, swimming pools, golf courses, boating environments, fishing environments, campgrounds, parks, and other water activities and locales. Further, the protective case provides protection to smartphones used by persons who work in outdoor environments, such as groundskeepers, farmers, rangers, construction workers, postal workers, police, and others who are subject to direct contact with rain.

The protective case comprises a front wall 102, a rear wall (not shown), and a plurality of sidewalls 106a, 106b. The front wall may include a protrusion 104. The rear wall may include a hinge. In some embodiments, the front wall and the rear wall may be disposed generally coplanar to each other, while the sidewalls may be disposed generally perpendicular to the front and rear walls; thereby forming a substantially rectangular shape. In one embodiment, the generally flat, rectangular shape formed by the walls is sized and dimensioned to contain a communication device, such as a smart phone, and at least one item, such as a credit card. The shape and dimension also helps restrict passage of moisture to the communication device and item. Though in other embodiments, any shape and size may be formed from the walls. In one embodiment, the walls and sidewalls form a rectangle approximately five and one-half inches in length by two and seven-eighths inches in width by one half-inch in depth (5½″×2⅞″×½″).

In some embodiments, the walls and sidewalls may form an opening, a first compartment, and a second compartment. The first compartment may have a generally flat, rectangular shape and be larger than the second compartment. The first compartment may be sized to contain a communication device, such as a smart phone. _{[EA1]}The second compartment may be sized and dimensioned to contain a thin item, such as a credit card, a license, medical pills, and a key. The second compartment may be thinner than the first compartment. In one embodiment, the second compartment measures approximately three and one-half inches in length by two and one-quarter inches in width by three-eighths of one inch in depth (3½″×2¼″×⅜″).

In some embodiments, the walls are fabricated from a lightweight, buoyant material that enables floatation of the protective case and the contained communication device and item. The walls may also be fabricated from a material that inhibits shock forces from damaging the communication device and item. Suitable materials for the protective case may include, without limitation, polyethylene, polypropylene, a hollow polymer, rubber, and latex.

In some embodiments, an opening forms above the compartments. The opening may be selectively covered by a lid 110 to enable access to the communication device and item, and also to restrict passage of moisture in the compartments. The lid may hingedly open and close over the compartments through use of the hinge. In some embodiments, the hinge positions on the rear wall. Though the hinge may also position on the front wall. The lid comprises a latch 112 that helps fasten the lid to a closed position over the compartments by coupling with the protrusion from the front wall. In this manner secure moisture resistant closing of the lid may be at least partially achieved. Thus, at least partial restriction of moisture into the compartments is possible.

In some embodiments, a grip portion 108a, 108b may extend along the length of the sidewalls. The grip portion may include a pair of textured rubber surfaces extending along the length of the sidewalls that enable gripping and secure manipulation of the protective case, even when moisture is present, or under slippery handling conditions. In one alternative embodiment, the grip portion may cover a substantial portion of the front wall and rear wall.

In some embodiments, a tethering portion 116 detachably attaches the protective case and the contained communication device and item to a user. The tethering portion is configured to be length adjustable for adjustable attachment of the protective case to the user. The tethering portion may include a lanyard, a bungie string, or a cord that is configured to pass around the neck, shoulder, or wrist for tethering the protective case to the user or a mounting surface.

In some embodiments, the tethering portion forms a loop and comprises a neck end 118 that attaches to the lid or walls, and a fastening end 120 that enables attachment to a fastener 122. The fastener is configured to clip the protective case around the neck of a user, or to a mounting surface, or to an object. In any case, the fastener enables facilitated detachment. In one exemplary embodiment, the fastener is a spring loaded clip. Though any mechanism that functions through clipping, latching, clamping, piercing, or magnetization may be used as a fastener. The fastener end 122 of the tethering portion may detachably attach to at least one attachment hole located in the walls or sidewalls. In one embodiment, the fastener is a spring-loaded clip that hooks through at least one attachment hole, or eyelet.

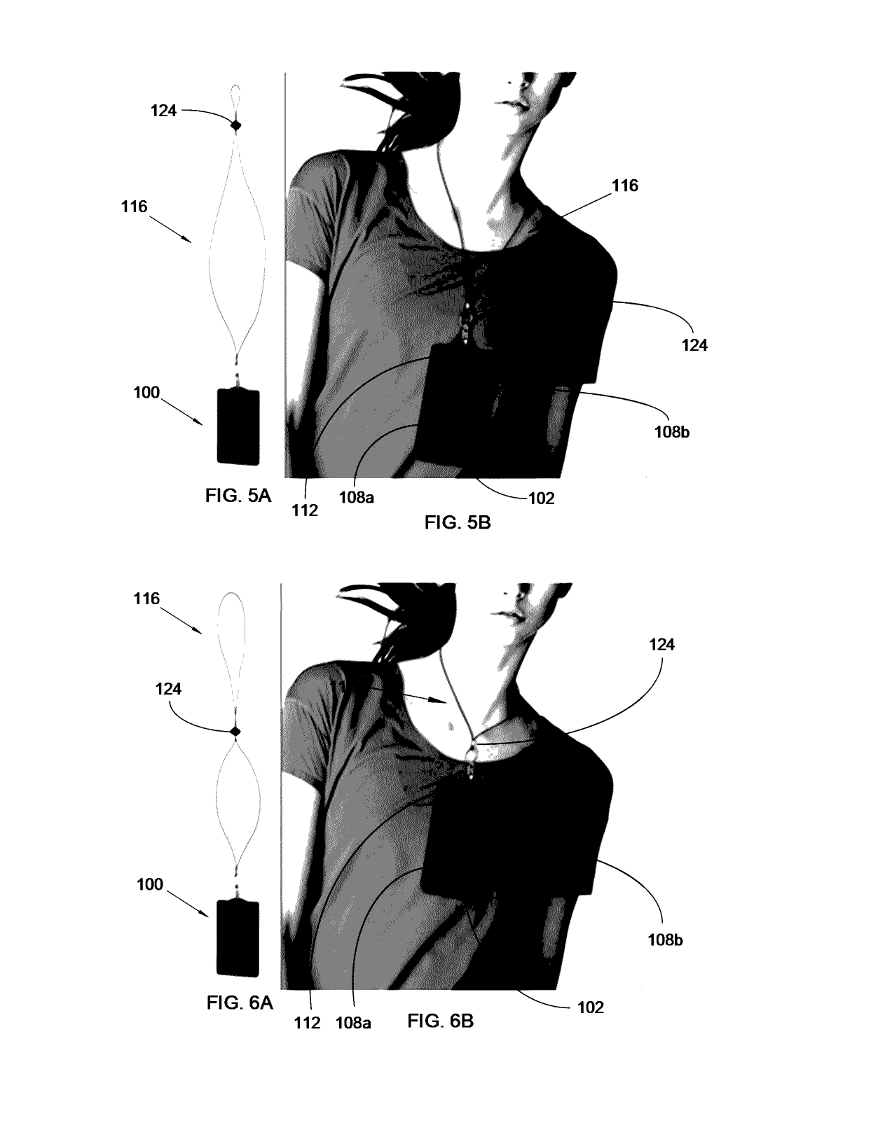

In some embodiments, a tether locking portion 124 slides along the tethering portion. The tether locking portion enables a loop to be set along the length of the tethering portion. In one exemplary use, the tethering portion is a cord and the tether locking portion is a spring loaded tension slide, or a bracket having a central bore that enables the tethering portion to pass. The tether locking portion is configured to slide along the cord until a desired length or loop size for the tethering portion is achieved (See FIGS. 5A, 5B, 6A, 6B).

In some embodiments, the protective case may further include at least one attachment hole 114a, 114b. The at least one attachment hole may include two oppositely disposed attachment eyelets, slots, or channels diametrically located at the sidewall and the lid. The attachment holes are configured to enable detachable attachment of the fastener end of the tethering portion from the lid, and a fastening mechanism, such as a key, from the opposite end of the lid. Though in other embodiments, the attachment hole may position along the front wall, rear wall, or sidewall.

FIG. 2 illustrates a close-up view of an exemplary lid in a closed position and an open position showing an exemplary first compartment and an exemplary second compartment. In one aspect, the communication device and the item are protected from accidental damage from a body of liquid, such as being dropped in a bathtub or lake. To help restrict contamination by moisture, the lid selectively closes and opens over the compartments that contain the communication device and item through use of a hinge 200. Though in other embodiments, the lid may slide or snap over the opening to cover a first compartment 202 and a second compartment 204.

In some embodiments, the protective case may also protect against passage of moisture through use of a first seal 206 and a second seal 208. The first seal may position along the perimeter of the opening at the walls. The second seal may position on the lid. In the closed position the first and second seals align with each other and fully engage to form a tight barrier that helps restrict the passage of moisture into the compartments. In one embodiment, the seals are rubber gaskets.

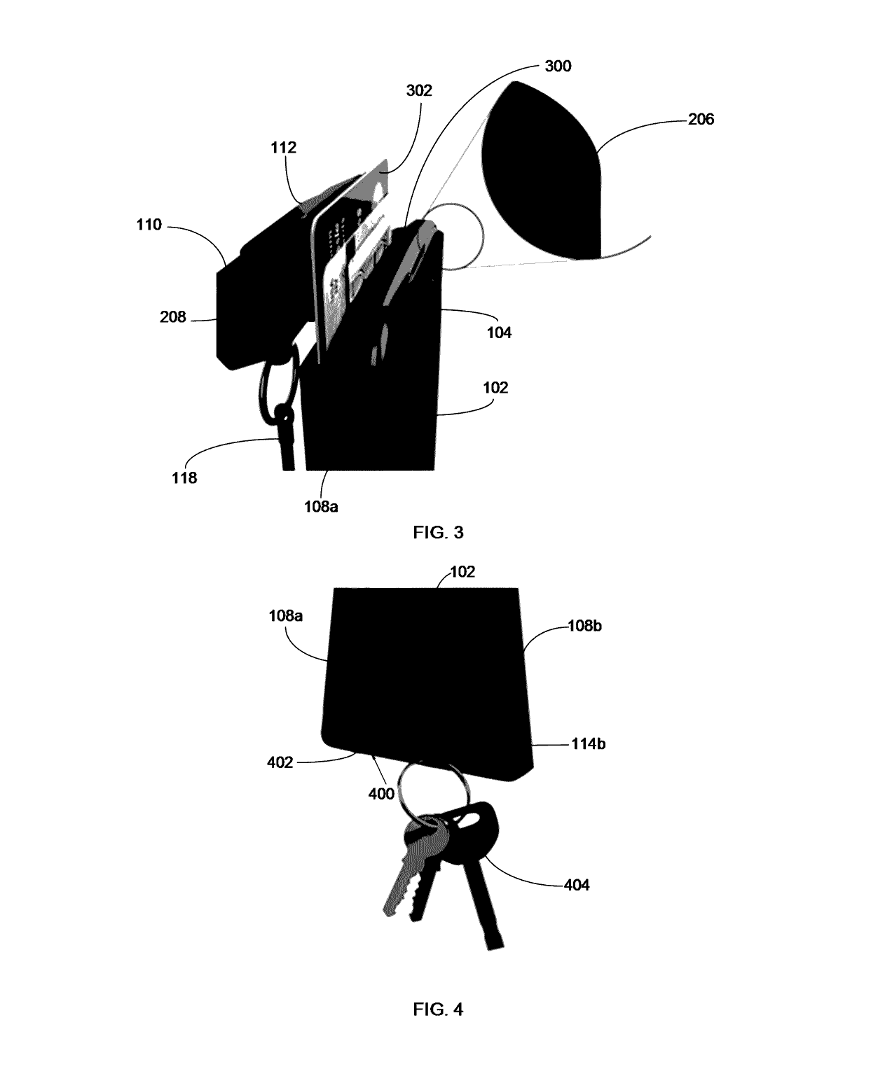

FIG. 3 illustrates a close up view of a first compartment receiving a communication device 300 and a second compartment receiving at least one item 302. In one aspect, the communication device in the first compartment may include, without limitation, a smart phone, a tablet, a laptop, and a radio. The at least one item may include, without limitation, a credit card, a license, a coin, a paper currency, a medicine pill, a key, a software disc, and a data storage device. In one alternative embodiments, the communication device and the item may interchange compartments.

FIG. 4 illustrates a bottom perspective view of an exemplary aperture for receiving a cable, and at least one opening for detachably attaching the protective case with a fastening mechanism. In one aspect, the sidewalls of the protective case may include an aperture 400 that aligns with a socket in the communication device. The aperture is configured to receive a cable that carries a signal to the communication device in the protective case. The cable may include a jack and USB cable for headphones or other electronic periphery. The cable may also include a battery-charging cable plug. In yet another embodiment, a cap 402 may cover the aperture to inhibit passage of moisture into the aperture. The cap may include a rubber material that forms a snug fit in the aperture.

In some embodiments, the attachment hole at the sidewalls enables detachable attachment to an object, such as a fastening mechanism 404. The fastening mechanism may include a key. Those skilled in the art will recognize that a key is necessary for water recreational vehicles. Thus, a synergy is created between the moisture proof configuration of the protective case and the attachable accessories for vehicles and activities associated with water.

FIGS. 5A and 5B illustrate front perspective views of an exemplary tethering portion, where FIG. 5A illustrates a tether locking portion distally positioned from the neck end, and FIG. 5B illustrates the protective case connected to the tethering portion, with the protective case hanging loosely around the neck. In one aspect, the tether locking portion slides along the tethering portion. The tether locking portion enables a loop to be set distally from the neck end, so as to form a large loop that can be worn around the neck of a user. This looser configuration may be useful when comfort and manipulation of the protective case is desired.

FIGS. 6A and 6B illustrate front perspective views of an exemplary tethering portion, where FIG. 6A illustrates a tether locking portion proximally positioned near the neck end, and FIG. 6B illustrates the protective case connected to the tethering portion, with the protective case hanging tightly around the neck. In one aspect, the tether locking portion slides along the tethering portion to enable a loop to be set proximally to the neck end, so as to form a small loop that can be worn around the neck of a user. This tighter configuration may be useful when engaged in physical activity and when manipulation of the protective case is not immediate. In any case, the size of the loop and length of the tethering portion is adjustable to suit different body sizes and needs.

In operation, a user may insert the communication device into the first compartment and then carry the protective case to any location, including near water. Further, the user may insert personal items into the second compartment, and attach keys to the attachment hole. The user may also wear the protective case around the neck through the tethering portion, and may adjust the size of the loop in the tethering portion that fits about the head with use of the length-adjusting tether locking portion.

The user can then enjoy the water environment without risk of damage to the smartphone from water contact, and without risk of accidental loss or theft. The other items included in the storage compartment will also be protected from water damage.

In one alternative embodiment, the protective case includes an illumination portion to enhance visibility in a body of water or at night. In another alternative embodiment, the tethering portion includes an adhesive, rather than a cord, so as to restrict movement of the protective case and communication device contained therein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a moisture proof protective case that encapsulates and protects a communication device and at least one item while also attaching to a length adjustable tether, a phone jack cable, and a fastening mechanism according to the present invention will be apparent to those skilled in the art. Various aspects of the invention have been described above by way of illustration, and the specific embodiments disclosed are not intended to limit the invention to the particular forms disclosed. The particular implementation of the moisture proof protective case that encapsulates and protects a communication device and at least one item while also attaching to a length adjustable tether, a phone jack cable, and a fastening mechanism may vary depending upon the particular context or application. By way of example, and not limitation, the moisture resistant protective case that encapsulates and protects a communication device and at least one item while also attaching to a length adjustable tether, a phone jack cable, and a fastening mechanism described in the foregoing were principally directed to a phone case that receives a phone and credit cards for protection against moisture and also includes a length adjustable tether and an aperture and moisture resistant cap for receiving a cable to the phone implementations; however, similar techniques may instead be applied to a case that provides moisture protection and floatation to any electrical device that can accidently fall into a body of water, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A case comprising:
a front wall, said front wall comprising a substantially buoyant material;
a rear wall, said rear wall comprising said substantially buoyant material, said rear wall disposed generally coplanar with said front wall;
a plurality of sidewalls, said plurality of sidewalls comprising said substantially buoyant material, said plurality of sidewalls being configured to join with said front wall and said rear wall to form a first compartment and a second compartment;
a lid, said lid comprising a substantially buoyant material, said lid being configured to at least partially cover said first compartment and said second compartment, said lid further being configured to be displaced between an open position and a closed position, said open position being operable to enable access to said first compartment and said second compartment, said closed position being operable to at least partially inhibit passage of moisture into said first compartment and said second compartment;
a first seal, said first seal being configured to join said front wall, said rear wall, and said plurality of sidewalls;
a second seal, said second seal being configured to join said lid, whereby said first seal and said second seal are configured to engage at said closed position, whereby said engagement of said first seal and said second seal at least partially inhibits passage of moisture into said first compartment and said second compartment;
a grip portion, said grip portion being configured to join with said plurality of sidewalls, said grip portion further being configured to enhance gripping said plurality of sidewalls;
at least one attachment opening, said at least one attachment opening being configured to enable detachable attachment with said plurality of sidewalls;
a tethering portion, said tethering portion comprising a neck end and a fastening end, said neck end being configured to join with said at least one attachment opening, said fastening end being configured to enable detachable fastening;
a tether locking portion, said tether locking portion being configured to enable adjustment of said tethering portion;
an aperture, said aperture being disposed at said plurality of sidewalls; and
a cap, said cap being configured to restrict passage of moisture into said aperture.

2. The case of claim 1, wherein said protective case is fabricated from a material that includes at least one member selected from the group consisting of: polyethylene, polypropylene, a hollow polymer, rubber, and latex.

3. The case of claim 2, wherein said front wall, said rear wall, and said plurality of sidewalls form a rectangle approximately five and one-half inches in length by two and seven-eighths inches in width by one half-inch in depth.

4. The case of claim 3, wherein said first compartment is configured to receive a communication device, and said second compartment is configured to receive at least one item.

5. The case of claim 4, wherein said front wall comprises a protrusion.

6. The case of claim 5, in which said lid comprises a latch.

7. The case of claim 6, wherein said latch is configured to engage said protrusion to enable fastening of said lid in said closed position.

8. The case of claim 7, in which said rear wall comprises a hinge, said hinge being configured to enable pivotal displacement of said lid between said open position and said closed position.

9. The case of claim 8, wherein said second compartment measures approximately three and one-half inches in length by two and one-quarter inches in width by three-eighths of one inch in depth.

10. The case of claim 9, in which said tethering portion comprises a lanyard.

11. The case of claim 10, further including a fastener, said fastener being configured to join with said fastening end of said tethering portion, said fastener further being configured to fasten to an object.

12. The case of claim 11, wherein said fastener comprises a spring-loaded clip.

13. The case of claim 12, in which said tether locking portion comprises a spring-loaded tension slide.

14. The case of claim 13, wherein said tether locking portion is configured to slide along said tethering portion.

15. The case of claim 14, wherein said aperture is configured to align with a socket in the communication device.

16. The case of claim 15, wherein said cap comprises rubber material.

17. The case of claim 16, wherein said at least one attachment hole is configured to detachably join with a fastening mechanism.

18. The case of claim 17, in which said fastening mechanism comprises a key.

19. A case comprising:
means for communicating;
means for containing said communication means;
means for at least partially restricting passage of moisture into said containment means;
means for mounting said containment means;
means for adjusting said mounting means;
means for receiving signals to said communication means; and
means for at least partially restricting passage of moisture into said signal receiving means.

20. A case consisting of:
a front wall, said front wall comprising a substantially buoyant material, said front wall further comprising a protrusion;
a rear wall, said rear wall comprising said substantially buoyant material, said rear wall disposed generally coplanar with said front wall;
a plurality of sidewalls, said plurality of sidewalls comprising said substantially buoyant material, said plurality of sidewalls being configured to join with said front wall and said rear wall to form a first compartment and a second compartment, said first compartment being configured to enable containment of a communication device, said second compartment being configured to enable containment of at least one item;
a lid, said lid comprising a substantially buoyant material, said lid being configured to at least partially cover said first compartment and said second compartment, said lid further being configured to be pivotally displaced between an open position and a closed position, said open position being operable to enable access to said first compartment and said second compartment, said closed position being operable to at least partially inhibit passage of moisture into said first compartment and said second compartment, said lid further comprising a latch, said latch being configured to engage said protrusion of said front wall for fastening said lid in said closed position;
a hinge, said hinge being configured to join said rear wall with said lid to enable said pivotal displacement of said lid;
a first seal, said first seal being configured to join said front wall, said rear wall, and said plurality of sidewalls;
a second seal, said second seal being configured to join said lid, whereby said first seal and said second seal are configured to engage at said closed position, whereby said engagement of said first seal and said second seal at least partially inhibits passage of moisture into said first compartment and said second compartment;
a grip portion, said grip portion being configured to join with said plurality of sidewalls, said grip portion further being configured to enhance gripping said plurality of sidewalls;
at least one attachment opening, said at least one attachment opening being configured to enable detachable attachment with said plurality of sidewalls;
a tethering portion, said tethering portion comprising a neck end and a fastening end, said neck end being configured to join with said at least one attachment opening, said fastening end being configured to enable detachable fastening;
a fastener, said fastener being configured to join with said fastening end of said tethering portion;
a tether locking portion, said tether locking portion being configured to enable adjustment of said tethering portion;
an aperture, said aperture being disposed at said plurality of sidewalls; and
a cap, said cap being configured to restrict passage of moisture into said aperture.
